(19) United States
(12) Patent Application Publication
(10) Pub. No.: US 2008/0001002 A1
(43) Pub. Date: Jan. 3, 2008

(54) FLUID DELIVERY SYSTEM FOR DISPENSING AN ACTIVE SUBSTANCE IN SPRAY FORM

(76) Inventor: Mark GARON, Saint-Hyacinthe (CA)

Correspondence Address: OGILVY RENAULT LLP, 1981 MCGILL COLLEGE AVENUE, SUITE 1600, MONTREAL, QC, H3A2Y3, CA

(21) Appl. No.: 11/757,508

(22) Filed: Jun. 4, 2007

Related U.S. Application Data
(63) Continuation of application No. PCT/CA05/01836, filed on Dec. 2, 2005.
(60) Provisional application No. 60/632,537, filed on Dec. 3, 2004.

(51) Int. Cl. B05B 7/30

(52) U.S. Cl. 239/67; 239/305; 239/308

(57) ABSTRACT

A delivery system (10) for dispensing an active substance in spray form comprises a head unit (10) including a valve (22) in communication with a dispensing nozzle (20), a first reservoir (14) containing a fluid propellant, and at least a second reservoir (16) containing the active substance. The first reservoir is engaged to the head unit in fluid flow communication with the valve, and the second reservoir is engaged to the head unit independently from the first reservoir and is in fluid flow communication with the dispensing nozzle. An actuation means (28) is operable to selectively open and close the valve. The valve, when open, permits at least the fluid propellant to flow out through the dispensing nozzle. The flow of fluid propellant entrains the active substance from the second reservoir into the fluid propellant for sprayed dispensing of the active substance from the delivery system.

### CROSS-REFERENCE TO RELATED APPLICATIONS

This application is a continuation of International Patent Application No. PCT/CA2005/001836 filed on Dec. 2, 2005 designating the United States of America, which PCT Application claims benefit of U.S. Provisional Patent Application No. 60/632,537 filed on Dec. 3, 2004, all of which are herein incorporated by reference.

### TECHNICAL FIELD

The invention relates generally to a fluid delivery system, and more particularly, to an aerosol-type delivery system having, the active fluids being dispensed by an independently contained gaseous propellant.

### BACKGROUND OF THE ART

Countless aerosol products are used in domestic households and in commercial and industrial applications. Aerosols are commonly used for the delivery of a variety of active substances, typically in liquid form, such as perfumes, air fresheners, repellents, cleaning products, paint, and countless other substances which may be dispensed in aerosolized form.

To dispense each of these various products, an aerosol can is used which contains both the aerosol product and the active substance. Typically, a closed top end of the aerosol can is provided with an aperture through which a conduit is inserted, at the top of which is mounted a dispenser valve actuator and a dispensing head having a nozzle, through which the aerosol is dispensed with the active substance contained in the can when the valve is manually activated.

For each and every active substance used, however, a separate can is necessary, the can containing both the active substance and the aerosol other than fluid propellant, which is the medium by which the active substance is dispensed and propelled out of the can in a spray or mist form. As such, many households and industrial workplaces are littered with a plurality of aerosol cans, each necessary for dispensing a different product. Such large collections of aerosol cans take up significant storage space, create large amounts of waste products when emptied and discarded, and unduly add to the expense required to dispense several different products via aerosol delivery means.

As such, there remains a need to provide an improved fluid delivery system which will address these problems.

### SUMMARY OF THE INVENTION

It is therefore an object of this invention to provide an improved fluid delivery system which can dispense a plurality of active substances.

In one aspect, the present invention provides a delivery system for dispensing at least one active substance in spray form comprising: a head unit including a valve in communication with a dispensing nozzle; a first reservoir containing a fluid propellant, said first reservoir being engaged to said head unit in fluid flow communication with said valve; at least a second reservoir containing said at least one active substance, said second reservoir being independent from said first reservoir and engaged in fluid flow communication with said dispensing nozzle; and an actuation means operable to selectively open and close said valve, said valve, when open, permitting at least said fluid propellant to flow out through said dispensing nozzle and said active substance to be transferred from said second reservoir into said flow of said fluid propellant for sprayed dispensing of said active substance from said delivery system.

In accordance with the present invention, there is also provided a fluid delivery device for dispensing at least one active substance in spray form using a gaseous propellant from a propellant reservoir to which said fluid delivery device is adapted for engagement, said fluid delivery device comprising: a head unit including a valve in communication with a dispensing nozzle, and an actuation means operable to open and close said valve, said valve being engageable in fluid flow communication with said propellant reservoir; and at least one reservoir containing said active substance therein, said reservoir being engaged with said head unit in fluid flow communication with said dispensing nozzle such that said active substance is transferred from said at least one reservoir and propelled from said fluid delivery device in spray form with a flow of said gaseous propellant flowing out through said dispensing nozzle.

There is also provided, in accordance with the present invention, a fluid delivery device for dispensing at least one active substance in spray form using a gaseous propellant, said fluid delivery device comprising a head unit including a fluid passage defined therein between a valve and a dispensing nozzle, an actuation means being disposed within said head unit and being operable to open and close said valve, said head unit being adapted for engagement to a propellant can containing said gaseous propellant therein such that said valve is in fluid flow communication with said gaseous propellant, said head unit having a venturi formed downstream of said valve which generates a low pressure region at a flow restricting portion thereof, a reservoir containing said active substance being engaged with said head unit in fluid flow communication with said venturi flow restricting portion, said gaseous propellant being adapted to flow through said dispensing nozzle when said valve is opened such that said venturi entrains said active substance into said gaseous propellant flow, forming a mixture of said active substance and said gaseous propellant which is sprayed out of said dispensing nozzle.

There is further provided, in accordance with another aspect of the present invention, a method of dispensing an active fluid from a first reservoir of a fluid delivery system using a gaseous propellant contained within an independent second reservoir, the method comprising generating a region of low pressure in a flow of said gaseous propellant downstream of a valve controlling said flow of said gaseous propellant between said second reservoir and a dispensing nozzle of the fluid delivery system, and using said region of low pressure in said flow of gaseous propellant to passively draw said actively substance out of said first reservoir and into said flow of gaseous fluid for sprayed dispensing of said active fluid from the fluid delivery system.

Further details of these and other aspects of the present invention will be apparent from the detailed description and figures included below.

### DESCRIPTION OF THE DRAWINGS

Reference is now made to the accompanying figures depicting aspects of the present invention, in which:

FIG. 1 is a side perspective view of a fluid delivery system in accordance with the present invention, having a replaceable reservoir engaged thereto;

FIG. 2 is a partially sectioned view of the dispensing head of the fluid delivery system of FIG. 1;

FIG. 3 is a side perspective view of an fluid delivery system in accordance with an alternate embodiment of the present invention, having an integrated removable reservoir engaged thereto;

FIG. 4 is a partially exploded perspective view of the fluid delivery system of FIG. 3;

FIG. 5 is a partially sectioned view of the dispensing head of the fluid delivery system of FIG. 3;

FIG. 6a is a partial side cross-sectional view of the discharge nozzle and active substance feed line of the embodiments of FIGS. 2 and 5 of the present invention;

FIG. 6b is a partial side cross-sectional view of a discharge nozzle and fluid delivery passage defining a venturi therein, in accordance with the present invention; and

FIG. 7 is a schematic cross-sectional view of a fluid delivery system in accordance with another alternate embodiment of the present invention, in which the active substance is contained within a reservoir formed in the dispensing head unit.

### DETAILED DESCRIPTION OF THE PREFERRED EMBODIMENTS

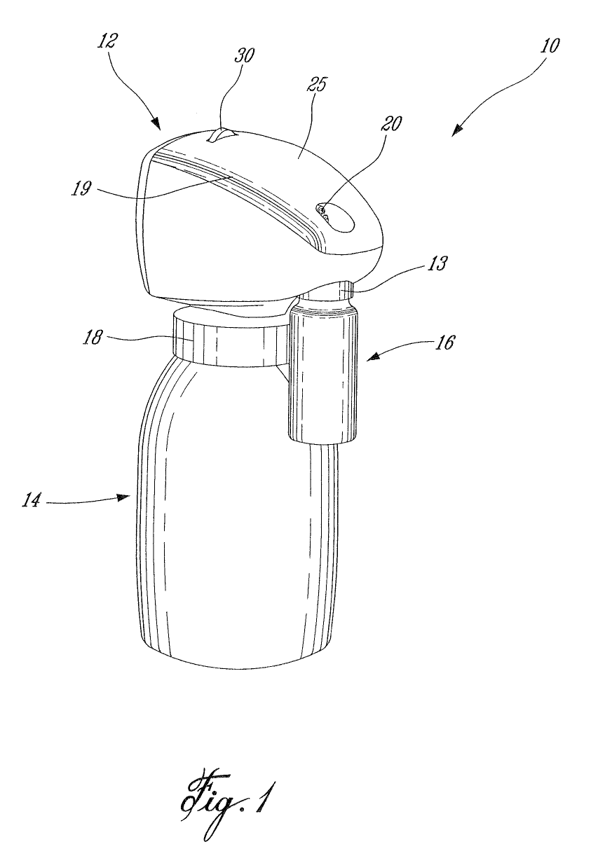

Referring to FIG. 1, the aerosol delivery system 10 is preferably portable and includes generally a head unit 12 mounted to a propellant reservoir 14, preferably in the form of a can which contains a fluid propellant therein while the propellant contained in the reservoir 14 may be an aerosol-based fluid, other compressed gases can similarly serve as the propellant such as pressurized air, CO₂, etc. The head unit 12 is preferably removably engaged to the can 14 via attachment collar 18, however the head unit 12 may be permanently fastened to the aerosol can. A second, independent, reservoir 16 is also provided, and which in the embodiment of FIG. 1 is removably engaged to the head unit 12, the second reservoir 16 containing an active substance for dispensing using the fluid delivery system. The term active substance as used herein is intended to include all fluids, and fluid-based substances having solid particles therein, which may be dispensed in a sprayed aerosol-type form. The aerosol propellant and the active substance are contained in separate, independent, reservoirs, each of which may be disengaged and re-engaged as required to the dispensing head unit 12. This permits the exchange or replacement of either, without requiring the other to be removed. As noted above, such an active substance is preferably a fluid, and as noted above may be any product which is dispensable in spray form, such as, for example only, perfumes, air fresheners, repellents, cleaning products, paint, and the like which is typically dispensed by an aerosol can. The active substance reservoir 16 may also contain fluids which are not typically dispensed in aerosol form, such as scented oils and the like.

The reservoir 16 containing the selected active substance may comprise a small canister, which is removably engageable to the head unit 12 at the opening 13 defined therein for receiving at least a portion of the replaceable canister. This is achieved by threading the reservoir 16 into the opening 13, or alternately fastening the reservoir in place using appropriate removable fastening elements. The canister or reservoir 16 may be thus removed from the head unit 12 and replaced with another similarly configured reservoir, when the active substance contained therein has been used up or alternately if a user should wish to change the active substance being dispensed by the aerosol delivery system 10. As such, a common or universal base unit is provided, made up at least of a source of aerosol propellant, contained in the aerosol reservoir 14 for example, and the head unit 12. To this common base unit, any one of a plurality of different reservoirs 16 containing different active substances may be selectively engaged thereto, such that the active substance contained in the reservoir 16 selected is dispensed by the system. Therefore, only the relatively small container or reservoir 16 which contains the active substance itself need be interchanged or replaced by another without having to replace or discard the dispensing head unit 12 and the aerosol source container 14.

In an alternate embodiment of the present invention, at least two fluid reservoirs 16, each containing a different active substance, are engaged with the head unit 12 of the delivery system 10, each being independently dispensed by the nozzle 20, or several such nozzles. Each such fluid reservoir 16 may be either removably engaged to the head unit 12 or alternately integrated therein such that while not removable, each may be refillable. This permits several different fluids used as active ingredients to be selectively dispensed. For example, several different scented oils may be engaged in separate canisters 16, the user then being able to select which particular scent is to be dispensed. Alternately, if the delivery system is being employed to dispense paint in a sprayed form, the user may select to dispense several different paint colors in quick succession without having to switch devices, as the one propellant source is used regardless of which active substance is chosen from their respective discrete canisters. This eliminates requiring many different aerosol paint cans, one for each paint color.

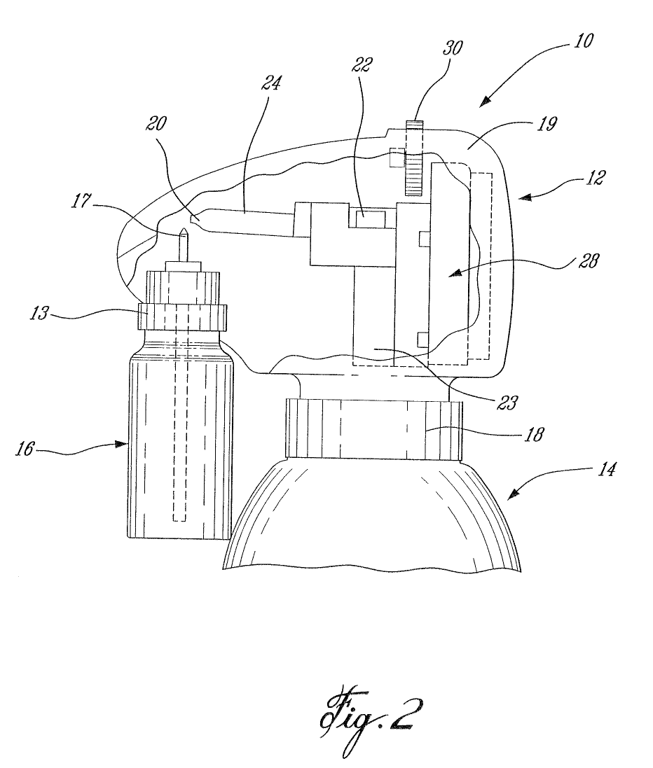

Referring to FIG. 2, the head unit 12 includes an outer casing 19 having an opening 25 therein through which the dispensing nozzle 20 projects, or at least through which the discharge from the dispensing nozzle 20 sprays. The head unit 12 further includes a valve 22 which is in fluid flow communication with the dispensing nozzle 20 via a fluid passage 24. The valve 22 as depicted is preferably operated by an actuation means 28 for opening and closing the valve 22, which may include a solenoid, an electric actuator, a manually operable valve actuating element (such as a push-button, for example) or any other suitable mechanism capable of selectively opening and closing the valve. In the depicted embodiment, the valve 22 is operable by the electrically driven solenoid of the actuation means 28 to open and close the valve when desired. The actuation means preferably also includes an electronic device contained within the outer casing 19 of the head unit 12 which is operable to automatically and remotely activate the solenoid, thereby allowing for the valve 22 to be opened and closed at any interval and for any duration desired. A control switch 30 is provided with the actuation means 28 to allow adjustment thereof, such that the period, duration, spray type, and the like can be varied as desired by a user. Alternately, if the valve 22 is a manually operable valve, the actuation means 28 includes a valve control linkage which opens and closes the valve when the control switch 30 is manually actuated by a user. In this case, the control switch 30 may simply be a push-button switch which opens the valve 22 when depressed, and closes the valve when released.

The valve 22 is provided in fluid flow communication with both the dispensing nozzle 20 and the propellant passage 23 defined in the head unit 12 between the valve 22 and the opening of the propellant reservoir 14. Particularly, the valve 22 is provided in series between the dispensing nozzle and the source of propellant, namely the base propellant reservoir 14. When the valve 22 is opened, the propellant from the main propellant reservoir 14 is therefore permitted to flow out through the passage 23, through the open valve 22, and down the fluid passage 24 to the dispensing nozzle 20. The reservoir 16 containing the active substance is in fluid flow communication with the dispensing nozzle 20. As such, when the valve 22 is opened, allowing the propellant to flow out of the reservoir 14, the active substance is fed out of the active substance reservoir 16 and mixes with the fluid propellant, such that this mixture is dispensed in spray form from the delivery system 10.

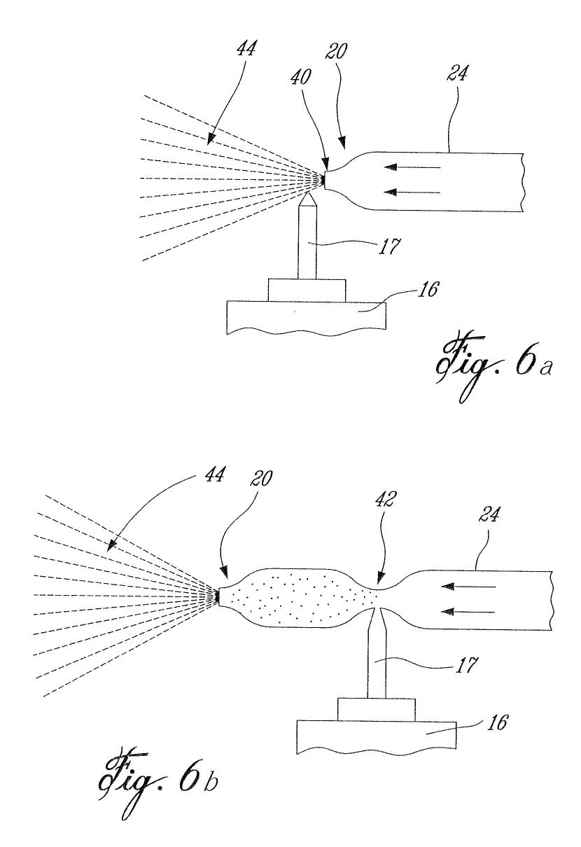

The head unit 12 comprises a passive delivery system which entrains the active substance out from the reservoir 16 and into the flow of fluid propellant when the valve 22 is opened. This passive delivery system includes a means for forming a low pressure region downstream of the valve, the low pressure region entraining the active substance from the reservoir into the fluid propellant. Thus, the fluid-based active substance is preferably passively drawn out of the replaceable reservoir 16 by the stream of propellant gas flowing out of the delivery system. The active substance accordingly preferably mixes with the propellant directly at the exit of the dispensing nozzle 20, as depicted in FIGS. 2, 5 and 6a, or alternately upstream thereof within said fluid passage 24, as depicted in FIG. 6b. This passive entrainment of the active substance from the replaceable reservoir 16 with the released propellant gas from the discrete propellant reservoir 14, thus allows for a simplified construction of the head unit 12. Alternately, however, it remains possible to actively feed the active substance out of the reservoir 16 and inject it into the stream of released propellant gas, such as by pumping, pressurization, or otherwise forcing the fluid of the active substance out of its reservoir 16.

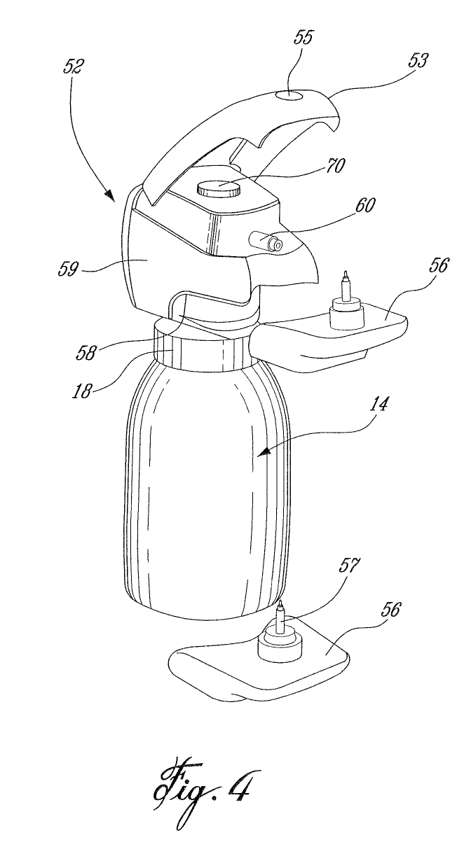

As best seen in FIGS. 6a and 6b, the fluid-based active substance from the replaceable reservoir 16 is passively drawn out through the outlet tube 17 thereof by creating a region of low pressure immediately adjacent, or at least proximate, thereto. Such a low pressure region created at the exit of the reservoir 16 draws the fluid therein out without requiring any mechanical pumping means or the like. Released gaseous propellant, such as an aerosol for example, from the reservoir 14 of the system flows through the fluid passage 24 toward the exit nozzle 20. In the first embodiment of FIG. 6a (and the embodiments depicted in FIGS. 1-5), the exit 40 of the nozzle 20 increases the velocity of the aerosol jet, and thus creates a local depression immediately downstream thereof. In effect, the nozzle exit 40 becomes a venturi and draws the active substance up and out of the reservoir outlet tube 17, and therefore into the aerosol spray exiting the nozzle in the spray cone 44 formed by a mixture of the aerosol propellant and the active substance. Alternately, as depicted in FIG. 6b, the low pressure region may be created upstream of the nozzle 20 by a venturi, 42 formed in the fluid passage 24 extending between the upstream valve 22 and the discharge nozzle exit 20. In this case, the outlet tube 17 of the reservoir 16 opens directly into the throat of the venturi 42, such that the local low pressure generated at the throat thereof acts to draw the active substance out of its reservoir 16 thereby entraining the active substance into the flow of aerosol propellant flowing through the fluid passage 24. The mixture of active substance and aerosol propellant accordingly flows downstream from the venturi 42 to the exit of the nozzle 20, which increases the velocity of the mixture and ejects the same out of the system in a spray cone 44.

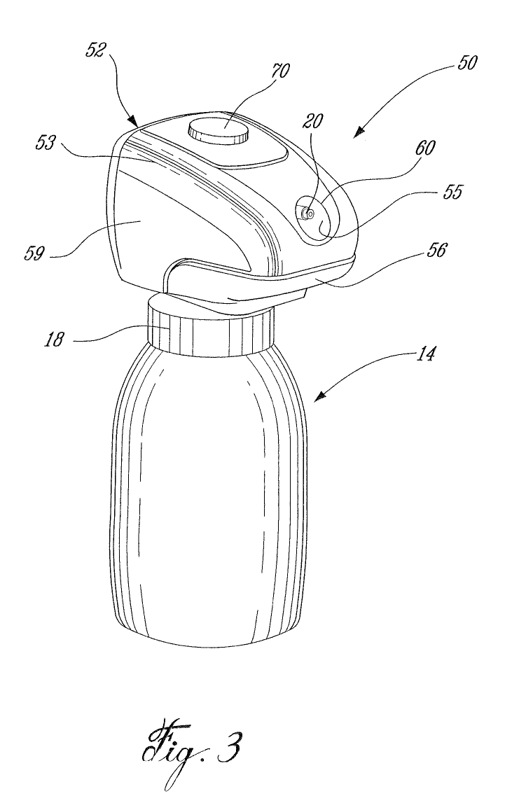

Referring to FIGS. 3 to 5, a fluid delivery system 50 in accordance with another embodiment of the present invention is depicted, the fluid delivery system 50 generally having a head unit 52 which is similarly engageable to a propellant reservoir 14 by a collar member 18. However, the head unit 52 comprises a fluid reservoir 56 which contains therein the active substance, the reservoir 56 being removable from the head unit 12 but nonetheless integrated therein. The active substance reservoir 56 is thus removable such that it can be replaced with another similar reservoir, or alternately so that it can be refilled before being re-engaged in place within the opening 58 defined in the head unit 12 for receiving the reservoir. This differs aesthetically from the canister-type reservoir 16 of FIGS. 1-2, however practically fulfills the same role, namely containing and providing the fluid active substance for dispensing using the compressed propellant such as aerosol contained independently within the reservoir 14.

The head unit 52 includes an outer casing having an upper portion 53 and a lower main body portion 59. The main body portion 59 defines the opening 58 therein for receipt of the correspondingly shaped active substance reservoir 56. The upper casing portion 53 is preferably hinged with the main body portion 59, such that the upper casing portion 53 may be swung open, as depicted in FIG. 3, thereby allowing access to the discharge nozzle 60 and allowing the reservoir 56 to be removed or replaced within the opening 58 of the head unit 52. The upper casing portion 53 also defines a forward opening 55 therein, through which the dispensed spray exits the delivery system 50 via the discharge nozzle 60 aligned with this opening 55.

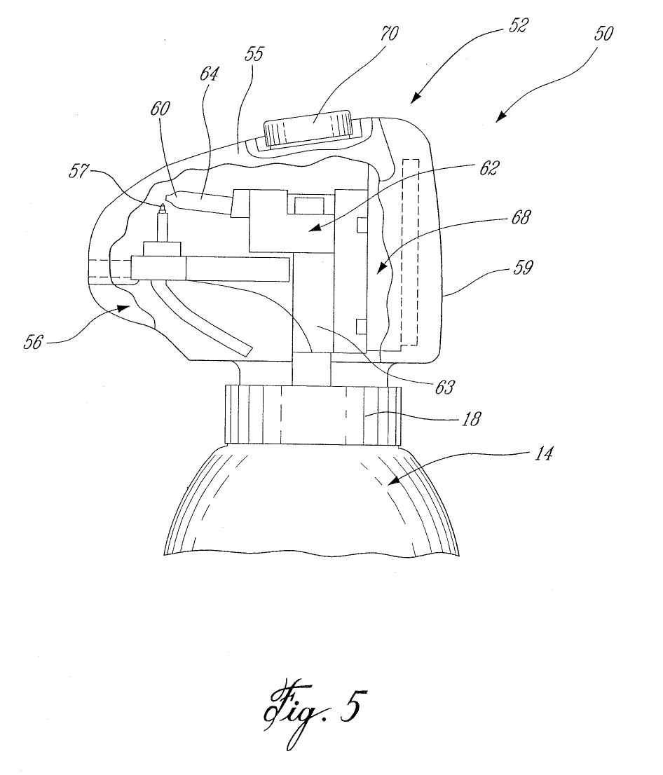

As best seen in FIG. 5, the head unit 52 of the aerosol delivery system 50 includes, much as per the head unit 12 of FIG. 2, a valve 62 which is in fluid flow communication with the dispensing nozzle 60 via a fluid passage 64. The valve 22 is preferably operated by an actuation means 68 which preferably includes an electrical solenoid, which is driven to open and close valve. However, the valve may alternately be a manually operable valve, in which case the actuation means 68 includes a valve control linkage which opens and closes the valve when the control switch 70 is manually actuated by a user. In this case, the control switch 70 may simply be a push-button switch which opens the valve 62 when depressed, and closes the valve when released.

The valve 62 is nonetheless preferably automatically and remotely operable by the electrically driven solenoid of the actuation means 68. A programmable electronic device, such as a microcontroller or corresponding circuitry, is preferably provided to control the operation of the actuation means 68, and therefore the solenoid driven valve. As such, the valve 62 may be opened and closed at any time interval and for any duration desired by programming this information into the microcontroller or by simply adjusting the control switch 70 which varies the solenoid actuation based on predetermined values. The control switch 70 therefore permits the control and adjustment of variables such as time period between each delivery of the active substance, duration of each spray delivered, spray type and the like. The valve 62 is provided in fluid flow communication with both the dispensing nozzle 60 and the aerosol passage 63 defined in the head unit 52 between the valve 62 and the opening to the aerosol reservoir 14. The valve 62 is therefore provided in series between the dispensing nozzle 60 and the source of aerosol propellant, namely the base aerosol reservoir 14. Accordingly, when the valve 62 is opened, the aerosol propellant from the reservoir 14 flows out through the aerosol passage 63, through the open valve 62, and down the fluid passage 64 to the dispensing nozzle 60.

The active substance reservoir 56 mounted within the head unit 52 includes an outlet tube 57, which projects into the reservoir and extends outward therefrom. The outlet tube 57 is disposed immediately downstream of the exit of the discharge nozzle 60 when the reservoir 56 is mounted in place within the head unit 52. As such, the active substance within the reservoir 56 is provided in fluid flow communication with the local depression created at the outlet of the discharge nozzle 60, thereby drawing the active substance up out of its reservoir via the outlet tube 57 and entraining the active substance into the gaseous jet of aerosol propellant forced out of the nozzle 60 when the valve 62 is opened. As described above, this provides a passive system for dispensing the active substance contained within a reservoir independent from the reservoir containing the gaseous propellant.

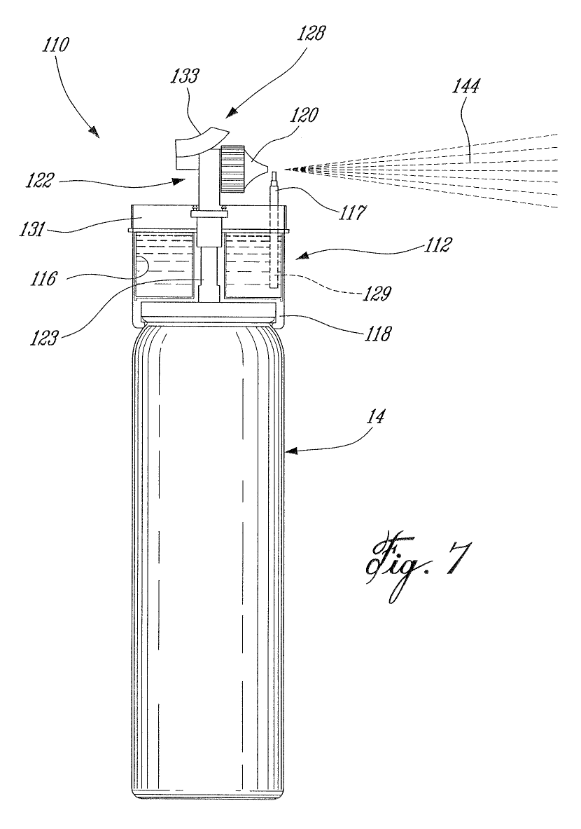

Referring now to the alternate embodiment of FIG. 7, the fluid delivery system 110 includes generally a head unit 112 mounted, either removably or permanently, to a propellant reservoir 14, preferably in the form of a can which contains the fluid propellant therein. As per the fluid delivery systems above, the propellant may be any fluid or fluid-based propellant product, such as, for example only by not limited to, an aerosol propellant (such as hfc134, hfc152, propane, butane, or any combination thereof) or alternately a compressed gas (such as O₂, CO₂, N₂, compressed air, or any combination thereof) for use as the propellant. The fluid propellant, regardless of type, is contained within the reservoir or canister 14, to which the head unit 112 is mounted. The entire fluid delivery system may be disposable, in which case the head unit 112 may be permanently fastened to the propellant canister 14 such that the entire system is to be thrown away once all the propellant fluid within the canister 14 has been consumed. However, the head unit 112 may be removably engaged to the top of the propellant canister 14, such that once consume the head unit 112 can be disengaged from the used-up canister 14 and engaged on a new propellant canister.

The head unit 112 is preferably removably engaged to the aerosol can 14, using an attachment collar portion 118, which may be integrated into the casing body of the head unit 112 as depicted in FIG. 7, or alternately may be a separate sliding collar as per the embodiments of FIGS. 1-5.

A second, independent, fluid reservoir 116 is provided, and within which the active fluid substance is contained. Contrary to the embodiment of FIG. 1 above in which the active substance reservoir is removably engaged to the head unit, the fluid reservoir 116 is integrated directly into the head unit 112, and thus contained directly therewithin. Accordingly, the reservoir 116 is not removable from the head unit 112, however it may be accessible such as to permit the re-filling thereof once all the active substance therein has been dispensed. For example, the upper cap portion 131 of the head unit 112 may be engaged thereto in sealed engagement but disengageable therefrom such as to permit the user to add new active substance directly into the integrated reservoir active substance reservoir 116. Alternately still, the cap portion 131 may be permanently sealed with the rest of the head unit body, however a sealable inlet port (not shown) may be provided such as to permit active fluid to be injected into the reservoir 116 when empty. Alternately still, the head unit 112 may be designed such as to be dispensable, and as such the active fluid reservoir 116 within the head unit 112 may be completely enclosed, such that once empty the head unit is simply discarded and replaced with a new one.

The head unit 112 further comprises a dispensing nozzle 120 which projects outwards therefrom. A valve 122 which is in fluid flow communication with the dispensing nozzle 20 is operated by an means for actuation 128, the means for actuation 128 of the valve 122 comprising, in at least the embodiment depicted in FIG. 7, a manual actuator 133 in the form of a push-button type actuator which acts to open the valve 122 when depressed by the user. However, as described above, the actuation means 128 may alternately comprise a solenoid or other electrically operated actuating mechanism which is remotely operable and controlled as desired.

The valve 122 is provided in fluid flow communication with both the dispensing nozzle 120 and the propellant passage 123 which extends substantially vertically between the valve 122 and the propellant canister/reservoir 14. Thus the propellant passage 123 extends through the active fluid reservoir 116, and mates with an opening or outlet of the propellant reservoir 14. Thus, the valve 122 is provided in series between the dispensing nozzle 120 and the source of aerosol propellant, namely the propellant reservoir 14. When the valve 122 is opened, the propellant gas from the reservoir 14 is therefore permitted to flow out through the propellant passage 123, through the open valve 122, and out to the dispensing nozzle 120, where the gaseous propellant is sprayed from the nozzle tip. The reservoir 116 containing the active substance is in fluid flow communication with the dispensing nozzle 120, as will be described below. As such, when the valve 122 is opened, allowing the pressurized propellant to flow out of the reservoir 14, the active substance is drawn out of the active substance reservoir 116 and mixes with the propellant, such that this mixture is dispensed in spray form from the aerosol delivery system 110. The fluid-based active substance is thus passively drawn out of the integral reservoir 116 of the head unit 112, via the exposed outlet tube 117 protruding from the top lid 131 of the head unit 112, by the stream of propellant gas flowing out of the tip of the nozzle 120. The outlet tube 117 is preferably connected in communication with a downwardly extending dip tube 129 which extends to near the bottom of the active substance reservoir 116.

The head unit 112 comprises a passive delivery system which entrains the active substance out from the reservoir 116 and into the flow of fluid propellant when the valve 122 is opened. This passive delivery system includes a means for forming a low pressure region downstream of the valve, the low pressure region entraining the active substance from the reservoir into the fluid propellant. Thus, the fluid-based active substance from the reservoir 116 is passively drawn out through the outlet tube 117 by the creation of the region of low pressure immediately adjacent, or at least proximate, the exit of the outlet tube 117. This low pressure region created at the exit of the active substance reservoir's outlet tube 117 is caused by the propellant nozzle 120, the nozzle exit of which increases the velocity of the propellant jet, and thus, acting like a venturi, creates a local depression immediately downstream thereof. As the exit of the propellant nozzle 120 is located immediately adjacent the exit of the outlet tube 117 of the active substance, the nozzle exit creates a venturi effect which draws the active substance up and out of the reservoir outlet tube 117, and therefore into the propellant spray exiting the nozzle 120, thereby forming the spray cone 144 comprised of a mixture of the propellant and the active substance.

The present invention therefore comprises, in at least one embodiment, a fluid delivery system which reduces the number of individual propellant cans needed by a user by including a universal gaseous propellant delivery base unit having a propellant reservoir and a dispensing head portion, to which any one of several detachable fluid reservoirs may be mounted, or alternately into which a fluid reservoir is integrated, each such fluid reservoir containing an active substance which is to be dispensed. In one embodiment, the active substance contained within the fluid reservoir is passively drawn out thereof by creating a local low pressure region in the propellant gas flow adjacent the outlet of the fluid reservoir.

Although the present invention has been described at least partially above with respect to an aerosol based propellant system, it is to be understood that other propellants, such as chemical propellants or alternately still any pressurized/compressed gas, may be used as the propellant for dispensing the selected active substance fluid. Particularly, the reservoir 14 may contain merely compressed air for use as a propellant for example. In such an embodiment, the reservoir 14 may be provided with means for re-pressurizing the air contained therein, such that replacement of the propellant reservoir 14 is never necessary. Other pressurized gases can similarly be used as the propellant, such as carbon dioxide for example. Alternately, pre-pressurized containers of air or another inexpensive and readily available gas may be engaged to the head unit 12 in place of the reservoir 14, and simply removed, discarded, and replaced by another when spent.

The above description is meant to be exemplary only, and one skilled in the art will recognize that changes may be made to the embodiments described without department from the scope of the invention disclosed. Still other modifications which fall within the scope of the present invention will be apparent to those skilled in the art, in light of a review of this disclosure, and such modifications are intended to fall within the appended claims.

1. A delivery system for dispensing at least one active substance in spray form comprising:
a head unit including a valve in communication with a dispensing nozzle;
a first reservoir containing a fluid propellant, said first reservoir being engaged to said head unit in fluid flow communication with said valve;
at least a second reservoir containing said at least one active substance, said second reservoir being independent from said first reservoir and engaged in fluid flow communication with said dispensing nozzle, said second reservoir being replaceable with another reservoir containing at least one of said active substance and a different active substance; and
an actuation means operable to selectively open and close said valve, said valve, when open, permitting at least said fluid propellant to flow out through said dispensing nozzle and said active substance to be transferred from said second reservoir into said flow of said fluid propellant for sprayed dispensing of said active substance from said delivery system.

2. The system as defined in claim 1, wherein said head unit comprises a passive delivery system which entrains said active substance out from said second reservoir and into said flow of fluid propellant.

3. The system as defined in claim 2, wherein said passive delivery system includes a means for forming a low pressure region downstream of said valve, said low pressure region entraining said active substance from said second reservoir into said fluid propellant.

4. The system as defined in claim 3, wherein said means for forming said low pressure region comprises a venturi, said low pressure region being defined at a throat portion thereof.

5. The system as defined in claim 4, wherein an opening to said second reservoir is defined in said fluid passage adjacent said venturi.

6. The system as defined in claim 3, wherein said means for forming a low pressure region includes an exit nozzle portion of said dispensing nozzle.

7. The system as defined in claim 6, wherein an outlet of said second reservoir is disposed proximate said exit portion of said dispensing nozzle.

8. The system as defined in claim 7, wherein said outlet is disposed immediately downstream of said exit portion of said dispensing nozzle.

9. The system as defined in claim 1, wherein said delivery system is portable.

10. The system as defined in claim 1, wherein said actuation means includes a solenoid operable to automatically dispense said active substance from said delivery system.

11. The system as defined in claim 1, wherein at least one of said first reservoir and said second reservoir is removably engaged with said head unit, such that said at least one of said first reservoir and said second reservoir is replaceable.

12. The system as defined in claim 1, wherein said second reservoir is contained within said head unit.

13. The system as defined in claim 12, wherein said second reservoir is integrally formed within said head unit.

14. The system as defined in claim 13, wherein said second reservoir is refillable in situ within said head unit.

15. The system as defined in claim 1, wherein said second reservoir is refillable when empty.

16. The system as defined in claim 1, wherein said actuation means is manually operable.

17. The system as defined in claim 16, wherein said actuation means includes a manual actuator operable to control said valve.

18. The system as defined in claim 1, further comprising at least two of said second reservoir, each containing a different active substance.

19. The system as defined in claim 18, wherein said two of said second reservoirs are removably engaged to said head unit.

20. The system as defined in claim 18, wherein said actuation means includes a solenoid operable to selectively dispense any one of said different active substances.

21. The system as defined in claim 1, wherein said fluid propellant includes at least one of an aerosol propellant and a compressed gas.

22. The system as defined in claim 21, wherein said aerosol propellant includes at least one of hfc134, hfc152, propane and butane.

23. The system as defined in claim 22, wherein said compressed gas includes at least one of oxygen, carbon monoxide, nitrogen and air.

24. A delivery system for dispensing at least one active substance in spray form comprising:
a head unit including a valve in communication with a dispensing nozzle;
a first reservoir containing a fluid propellant, said first reservoir being engaged to said head unit in fluid flow communication with said valve;
at least a second reservoir containing said at least one active substance, said second reservoir being independent from said first reservoir and engaged in fluid flow communication with said dispensing nozzle, said second; reservoir being contained within said head unit; and
an actuation means operable to selectively open and close said valve, said valve, when open, permitting at least said fluid propellant to flow out through said dispensing nozzle and said active substance to be transferred from said second reservoir into said flow of said fluid propellant for sprayed dispensing of said active substance from said delivery system.

25. A fluid delivery device for dispensing at least one active substance in spray form using a gaseous propellant from a propellant reservoir to which said fluid delivery device is adapted for engagement, said fluid delivery device comprising:
a head unit including a valve in communication with a dispensing nozzle, and an actuation means operable to open and close said valve, said valve being engageable in fluid flow communication with said propellant reservoir; and
at least one reservoir containing said active substance therein, said reservoir being engaged with said head unit in fluid flow communication with said dispensing nozzle such that said active substance is transferred from said at least one reservoir and propelled from said fluid delivery device in spray form with a flow of said gaseous propellant flowing out through said dispensing nozzle, said reservoir being replaceable with another reservoir.
